(19) United States
(12) Patent Application Publication
(10) Pub. No.: US 2023/0144418 A1
(43) Pub. Date: May 11, 2023

(54) Multipurpose common-pool based flooding-type management system for small modular reactors

(71) Applicants: Korea Advanced Institute of Science and Technology, Daejeon (KR); IUCF-HYU (Industry-University Cooperation Foundation Hanyang University), Seoul (KR)

(72) Inventors: Yong Hee KIM, Daejeon (KR); Jeong Ik Lee, Daejeon (KR); Taesuk Oh, Daejeon (KR); Seongdong Jang, Daejeon (KR); Sung Joong Kim, Seoul (KR); Doyoung Shin, Seoul (KR); Jae Hyung Park, Seoul (KR); Geonhyeong Lee, Seoul (KR); Joongoo Jeon, Seoul (KR); Taeseok Kim, Seoul (KR)

(21) Appl. No.: 17/983,021

(22) Filed: Nov. 8, 2022

(30) Foreign Application Priority Data
Nov. 10, 2021 (KR) 10-2021-0154030

(51) Int. Cl. G21C 15/12; G21C 11/08; G21C 13/024; G21C 15/18

(52) U.S. Cl. CPC G21C 15/12; G21C 11/083; G21C 13/024; G21C 15/182

(57) ABSTRACT

Disclosed herein is a reactor including a reactor vessel and a containment vessel configured to surround the reactor vessel. The containment vessel includes a thermal radiation shield disposed on an inner wall, and a gap between the reactor vessel and the containment vessel is in an atmospheric pressure and air atmosphere state.

### CROSS-REFERENCES TO RELATED APPLICATION

This patent application claims the benefit of priority under 35 U.S.C. § 119 from Korean Patent Application No. 10-2021-0154030 filed Nov. 10, 2021, the contents of which are incorporated herein by reference.

### BACKGROUND OF THE INVENTION

### 1. Field of the Invention

The present disclosure relates to a multipurpose common-pool based flooding-type management system for small modular reactors.

### 2. Description of the Related Art

Small modular reactors collectively refer to reactors that have a small thermal output (or electrical output) and are capable of being constructed as a modular concept by duplicating the same reactor as a concept in contrast to large-capacity power reactors. The small modular reactors are attracting attention in various aspects such as safety, technology, and applicability and are being developed as a new reactor for commercialization in some countries where it is difficult to introduce a large-capacity power plant.

The small modular reactors are attracting attention for various technical advantages and applicability and are often compared with the existing large-capacity reactors. The characteristics (advantages and disadvantages) of the general small modular reactors are as follows.

It has high safety and reliability because it is easy to apply new technologies such as intrinsic safety technology and passive safety technology. A construction period is short because it is completely manufactured and assembled at the factory to move to the site so as to be installed directly. A required site size is small, and a construction cost is low, and thus, a risk of the cost investment is low. Due to the small capacity scale, an emergency planning zone is reduced and limited to the site area. Since modular construction is possible, the capacity scale may be adjusted according to demands. It may be used as base power in areas with poor national power grids or low power demand. Although economics are inferior to that of the large-capacity reactors, it may have competitiveness when compared to other energy sources. There is a limitation in supply because the licensing system (standards, laws, etc.) is insufficient, and the infrastructure industry for equipment is not formed.

Looking at the small modular reactor technology, NuScale Power Corporation. disclosures a containment vacuum technology and an accident management system using a pool and heat exchangers.

The containment vacuum technology is a technology that maintains a vacuum state in a containment gap to minimize a heat loss during a normal operation, eliminate possibility of hydrogen combustion in an accident, and improve condensation performance. The vacuum condition has an advantage that the heat loss due to conduction and convection is excluded, but there is a weakness in terms of preventing the heat loss due to radiative heat transfer from occurring. In the normal operation, a temperature of an outer wall of a reactor pressure vessel is about 260° C. to about 330° C., which is usually low to generate radiative heat transfer, but when considering that an output of the small modular reactor reaches hundreds of MW, and a nuclear fuel replacement cycle is more than 18 months, a heat loss due to the radiative heat transfer is not negligible. As a result of performing computational fluid dynamics (CFD) analysis for the small modular reactor including the containment vessel having a height of 15 m, it is seen that, when the heat loss due to the radiation is not considered, an insulation effect is remarkable, but when the radiation is considered, a heat loss of about 350 kW occurs (see FIG. 1). As described above, the containment vacuum technology has a limit in minimizing the heat loss during the normal operation. In addition, it requires a vacuum pump that is always in operation to maintain a degree of vacuum, and it also causes additional costs in terms of management.

Looking at the accident management technology using the permanent flooded-type arrangement and heat exchanger, it is a technology that secures long-term cooling performance by removing residual heat of the reactor when an accident occurs using a permanent flooding pool and a heat exchanger, which is installed in the permanent flooding pool. This technology has an advantage of passively securing the long-term cooling performance, but water is always in contact with a metal containment vessel during a long fuel replacement cycle of 18 months to increase in amount of heat loss (see FIG. 1), thereby accelerating corrosion and aging of the containment vessel. In addition, since the total of 12 modules are installed in one pool without boundaries, when an accident occurs in one module, operations of other modules are inevitably affected. In addition, in the case of the small modular reactor having a very low thermal output, sufficient cooling performance is secured to remove the residual heat only by air cooling when all coolant in the limited pool is exhausted (see FIG. 2), but in the case of small modular reactors having a higher thermal output, there is a possibility that sufficient cooling performance is not ensured only with the above-described configuration and air cooling. When comparing only magnitude of decay heat, as illustrated in FIG. 3, if a heat output increases to about 450 MWt, magnitude of the decay heat after 30 days after reactor shutdown is about 2.6 times higher (if an operation period is conservatively assumed to be an infinite operation period). That is, an accident management system using such a heat exchanger and a pool has a limit in securing a long-term containment lifespan and being applied at a higher output.

### SUMMARY OF THE INVENTION

Embodiments of the present invention are directed to propose a new concept capable of minimizing a heat loss during a normal operation of an innovative small modular reactor and securing long-term cooling performance when an accident occurs.

According to an aspect of the present invention, there is provided a reactor including: a reactor vessel; and a containment vessel configured to surround the reactor vessel, wherein the containment vessel includes a thermal radiation shield disposed on an inner wall, and a gap between the reactor vessel and the containment vessel is in an atmospheric pressure and air atmosphere state.

According to another aspect of the present invention, there is provided a reactor modularization system including a reactor building in which at least two reactors are disposed, wherein the reactor building includes: a common pool in which coolant is contained; at least two cavities which are defined in an outer circumferential surface of the common pool and in which the reactors are disposed, respectively.

According to another aspect of the present invention, there is provided a method for removing decay heat using the reactor modularization system under a coolant leakage accident, the method including: performing emergency injection into each of cavities of a reactor building using a coolant of a common pool; and cooling an outer wall of a containment vessel and transferring decay heat of steam, which is discharged through a gap of the containment vessel from the reaction vessel, to an external coolant through condensation heat transfer.

According to another aspect of the present invention, there is provided a method for removing decay heat using the reactor modularization system under a coolant leakage accident, the method including: a process of passively removing the decay heat through a passive residual heat removing system to which a steam generator in a reactor vessel and a heat exchanger for removing passive residual heat inside an auxiliary pool are connected.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a graph illustrating an amount of heat loss for each gap filler in gas-type containment vessel using CFD-FLUENT in a 2D symmetric condition of about 15 m (full height).

FIG. 2 is a view illustrating an example of an accident management system using a pool and a heat exchanger of United States NuScale Power Corporation;

FIG. 3 is a graph illustrating results obtained by comparing decay heat after shutdown of a reactor and a 450 MWt core heat output reactor;

FIG. 4 is a schematic view illustrating a reactor according to an embodiment of the present invention;

FIG. 5 is a schematic view illustrating a reactor according to an embodiment of the present invention;

FIG. 6 is a schematic view illustrating structures of a common pool and reactors in the cavities disposed in the reactor building according to an embodiment of the present invention;

FIG. 7 is a cross-sectional view illustrating the common pool and the cavity, which are disposed in the reactor and a reactor building, in a direction a according to an embodiment of the present invention;

FIG. 8 is a cross-sectional view illustrating the common pool and the cavity, which are disposed in the reactor and a reactor building, in a direction b according to an embodiment of the present invention;

FIG. 9 is a cross-sectional view illustrating the common pool and the cavity, which are disposed in the reactor and a reactor building, in a direction c according to an embodiment of the present invention;

FIG. 10 is a schematic view illustrating an example of emergency injection using the common pool when a coolant leakage accident occurs;

FIG. 11 is a schematic view illustrating a decay heat removing process as time elapses; and

FIG. 12 is a schematic view illustrating an example of a concept of securing long-term cooling performance by using a passive residual heat removing system when an accident occurs without coolant leakage.

### DESCRIPTION OF THE PREFERRED EMBODIMENTS

Since the present invention may have diverse modified embodiments, specific embodiments are illustrated in the drawings and are described in the detailed description of the invention. However, this does not limit the present disclosure within specific embodiments and it should be understood that the present disclosure covers all the modifications, equivalents, and replacements within the idea and technical scope of the present disclosure.

In the following description, the technical terms are used only for explaining a specific exemplary embodiment while not limiting the present invention. The terms of a singular form may include plural forms unless referred to the contrary. In this application, the terms “comprises” or “includes” are intended to indicate that there is a feature, number, step, operation, component, part, or combination thereof described in the specification, and one or more other features. It is to be understood that the present invention does not exclude the possibility of the presence or the addition of numbers, steps, operations, components, components, or a combination thereof.

Unless defined otherwise, all terms used herein, including technical or scientific terms, have the same meaning as commonly understood by one of ordinary skill in the art. Terms such as terms that are generally used and have been in dictionaries should be construed as having meanings matched with contextual meanings in the art. In this description, unless defined clearly, terms are not ideally, excessively construed as formal meanings.

In the entire specification and claims, when it is described that one comprises (or includes or has) some elements, it should be understood that it may comprise (or include or has) only those elements, or it may comprise (or include or have) other elements as well as those elements if there is no specific limitation.

In one aspect of the present invention, a reactor 100 includes a reactor vessel 10 and a containment vessel 20 surrounding the reactor vessel 10. The containment vessel 20 includes a thermal radiation shield 21 disposed on an inner wall, and a gap 30 between the reactor vessel 10 and a containment vessel 20 is in an atmospheric pressure and air atmosphere state.

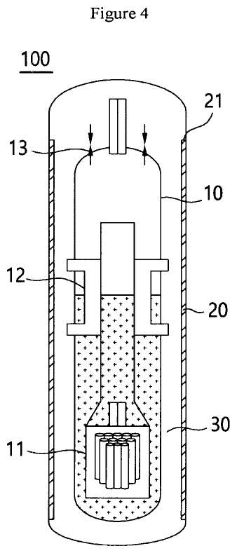

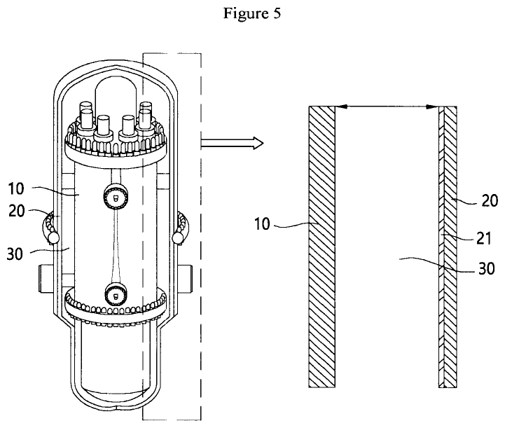

Here, FIGS. 4 and 5 are schematic views illustrating an example of the reactor provided in one aspect of the present invention. Hereinafter, the reactor provided in one aspect of the present invention will be described with reference to FIGS. 4 and 5.

When described with reference to an example of the reactor 100 provided in one aspect of the present invention, which is illustrated as a schematic view in FIG. 4, in particular, a reactor including the reactor vessel 10 and the containment vessel 20 surrounding the reactor vessel 10 is provided as a small modular reactor. The reactor vessel 10 may have a cylindrical shape or a capsule shape, and a reactor core 11 may be disposed at a lower portion of the reactor vessel 10. The reactor core 11 may contain an amount of fissile material to generate a controlled reaction that occurs over a period of several years. A control rod may be employed to control a fission rate in the reactor core 11 as illustrated in FIG. 4. The control rod may include silver, indium, cadmium, boron, cobalt, hafnium, dysprosium, gadolinium, samarium, erbium, and europium or alloys and compounds thereof. In addition, a steam generator 12 is provided inside the reactor vessel 10 to receive heat generated by a nuclear fission reaction and then generate a large amount of steam by using the received heat. A relief valve 13 is disposed above the reactor vessel 10 to adjust a pressure inside the reactor vessel 10, thereby preventing an overpressure from occurring.

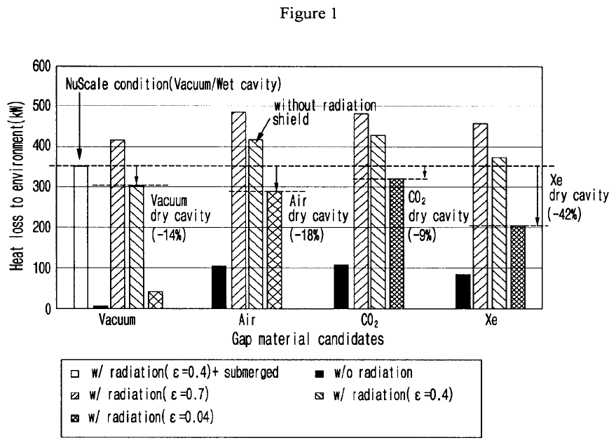

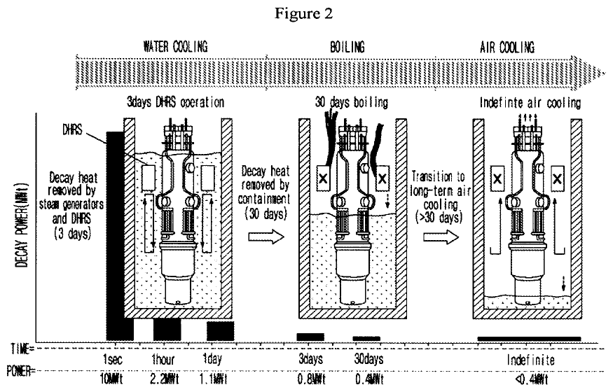

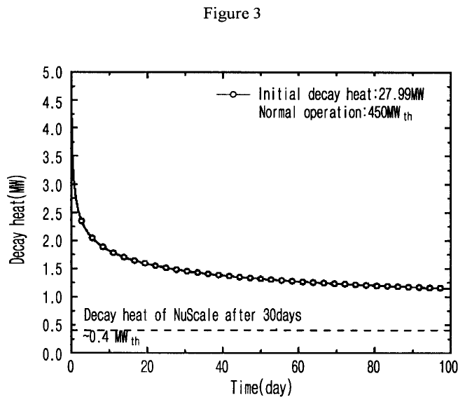

When described with reference to an example of the reactor 100 provided in one aspect of the present invention illustrated as schematic views in FIGS. 4 and 5, the containment vessel 20 may surround the reactor vessel 10, have a cylindrical or capsule shape, and is made of a metal material used as a general containment vessel. A gap 30 between the containment vessel 10 and the reactor vessel 10 may be in an atmospheric pressure and air atmosphere state. The gap 30 may be filled with a gas at the atmospheric pressure. The gap 30 may be maintained in the atmospheric pressure and air atmosphere state, and thus, a separate vacuum maintenance facility is not required. In addition, a replaceable thermal radiation shield 21 having a low emissivity (about 0.04) capable of shielding radiative heat transfer up to a height at which a high temperature is normally maintained during a normal operation (usually at an inlet side of an integrated steam generator) is installed on an inner wall of the containment vessel 20. When compared to the related art, an additional heat loss due to convection of air generated in the gap 30 through the thermal radiation shield 21 may be reduced to about 82% (see FIG. 1). Here, the installed thermal radiation shield 21 may be easily maintained and used efficiently when reloading a nuclear fuel.

Here, the thermal radiation shield 21 may be made of an aluminum-based metal. In addition, the atmospheric pressure may be in a pressure range of about 1.0 atm to about 1.2 atm, but may be in a generally considered atmospheric pressure range.

Further, in another aspect of the present invention, a reactor modularization system 1000 includes a reactor building 200 in which at least two reactors 100 are disposed, and the reactor building 200 includes a common pool 210, in which coolant is contained, and at least two cavities 220 defined in an outer circumferential surface of the common pool 210 so that the reactors 100 are disposed, respectively.

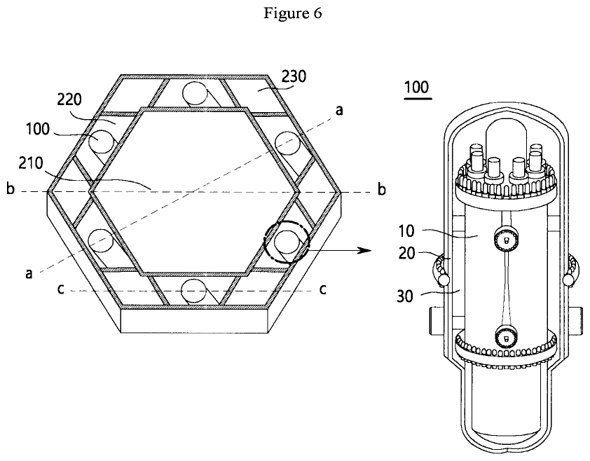

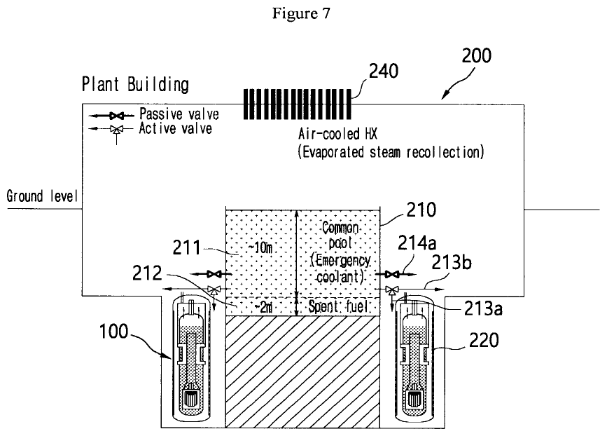

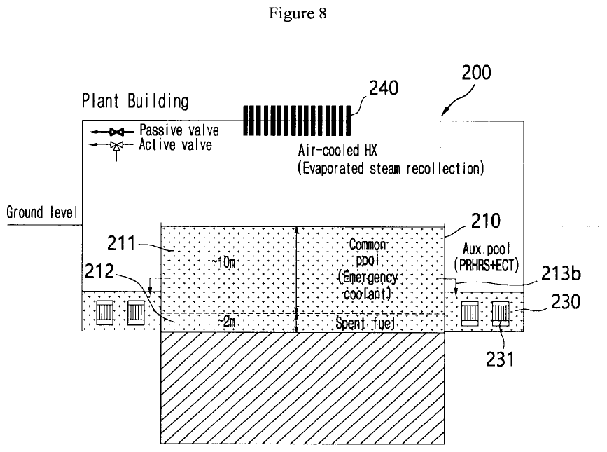

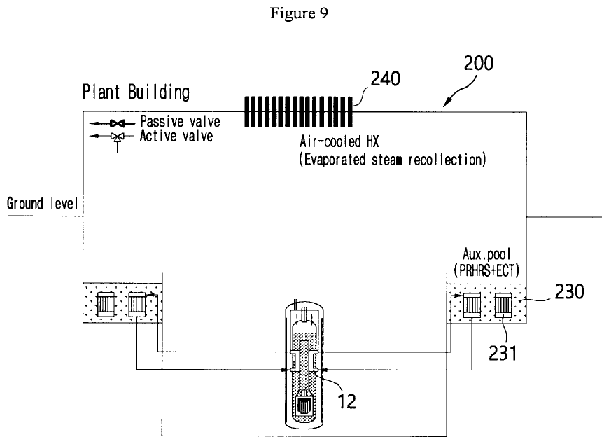

Here, FIGS. 6 to 9 illustrate schematic and cross-sectional views of an example of the reactor modularization system 1000 provided in another aspect of the present invention. Hereinafter, the reactor modularization system 1000 provided in another aspect of the present invention will be described in detail with reference to FIGS. 6 to 9.

In the present invention, a multipurpose common-pool 210 including the coolant contained in the reactor 100 and the reactor building 200 as a new concept capable of minimizing a heat loss during a normal operation of an innovative small modular reactor and securing long-term cooling performance in the event of an accident. Thus, individual insulation and spent nuclear fuel management functions during the normal operation may be performed, and a common role of securing long-term cooling performance of the reactor in the event of the accident may be performed together.

The above-described main roles of the reactor 100 are two, which are divided into a role of shielding a heat loss from the reactor vessel 10 during the normal operation and a role of removing residual heat by condensing steam discharged in the event of the accident of loss of the coolant. The reactor 100 surrounds the reactor vessel 10 through an air layer having excellent thermal insulation effect therein, and an aluminum-based replaceable thermal radiation shield 21 that prevents an additional heat loss due to radiative heat transfer is additionally provided on an inner wall of the containment vessel 20 surrounding the reactor vessel 10. The thermal radiation shield is designed to be easily replaced during inspection in consideration of possibility of a reduction in thermal shielding performance due to the thermal radiation.

In addition, in the reactor modularization system 1000, a concept of introducing a multi-purpose common pool 210 in which a very large pool is disposed at a center of the reactor building 200, and two or more reactors 100 are arranged around the pool. The reactor 100 is disposed in an underground cavity 220 in a dry condition without water to minimize the heat loss during the normal operation. The main role of the coolant in the multipurpose common pool 210 is to manage the spent nuclear fuel during the normal operation and to fill an emergency coolant into the cavity 220 in which the module constituted by two or more reactors installed in the accident situation is installed. The filled coolant acts as an ultimate heat sink for cooling the outer wall of the containment vessel 20, and thus, condensation of the discharged steam is performed inside the containment vessel 20.

Specifically, the cavity 220 may be maintained in the dry condition. The individually defined cavities 220 may be maintained in the dry condition rather than a flooded condition to prevent additional heat loss and corrosion, which are caused by water occurring in the related art. In addition, the number of the cavities 220 may be two or more, three or more, four or more, five or more, or six or more. For example, the common pool 210 may be provided in a hexagonal column shape, and the cavities 220 may be defined in each surface of the common pool 210 to provide six cavities 220.

In addition, the reactor building 200 may include an auxiliary pool 230 which is defined in the outer circumferential surface of the common pool 210 and connected to the common pool 210 through a pipe, and in which the coolant is contained. The auxiliary pool 230 may be provided between the individual cavities 220. For example, six auxiliary pools 230 may be provided between individually provided six cavities 220, respectively.

The auxiliary pool 230 may include a heat exchanger 231 for passively removing residual heat connected to a steam generator 12 inside the reactor vessel 10. The steam generator 12 may constitute the passive residual heat removal system to which the heat exchanger 231 for passively removing the residual heat is connected, to passively remove decay heat by natural circulation in the event of an accident without coolant leakage.

In addition, the reactor building 200 may include an air-cooled type heat exchanger 240 for condensing steam on an upper portion of the common pool 210. The steam generated by boiling in the cavity 220 may be cooled by air through the air-cooled type heat exchanger 240 installed on the upper portion of the reactor building 200 and then be re-collected into the common pool 210 to significantly securing an accident response time.

Furthermore, the common pool 210 may be divided into an upper portion 211 and a lower portion 212. Here, the upper portion 211 may be an aboveground portion at which the coolant is disposed, and the lower portion 212 may be an underground portion at which the coolant and the spent nuclear fuel are disposed. The spent nuclear fuel may be stored in the lower portion 212 disposed under the ground in the common pool 210, and all coolant within the common pool 210 may be used for cooling the spent nuclear fuel under the normal operation, and thus, possibility of exposure to the air may be significantly low.

In addition, the common pool 210 may include an active valve 213 and a passive valve 214 through which the coolant is injected into the cavity 220, and the common pool 210 may include the active valve 213 for injecting the coolant into the auxiliary pool 230. The active valve 213 may be provided as a three-way valve and may include a line 213a connected through the active valve 213 to inject the coolant into the individual cavity 220 and a line 213b for injecting the coolant into the auxiliary pool 230. In addition, the common pool 210 may include a line 214a connected through the passive valve 214 to inject the coolant into the individual cavities 220. As described above, since the active valve 213 and the passive valve 214 are provided, when power is turned off due to the coolant leakage accident, the coolant may be uniformly injected into the individual cavities 220 through the passive valve 214, and when the electric power (AC) is available, the active valve 213 disposed at a side of the module, in which the accident occurs, may operate to perform the cooling in only the module, in which the accident occurs.

The most important factor under the normal operation condition is to minimize an amount of heat loss from the reactor vessel 10 and to prevent the spent nuclear fuel from being exposed to the atmosphere. In the reactor 100 and the reactor modularization system 1000 including the reactor 100 proposed in the present invention, the individual cavities 220 in which two or more reactors 100 are disposed may be maintained in the dry condition to realize the excellent insulation effect because there is no water that increases in heat loss, and the aluminum-based thermal radiation shield 21 having a very low emissivity may be provided inside the containment vessel 20 to efficiently block the heat loss due to the thermal radiation. The spent nuclear fuel may be stored in the lower portion 212 disposed under the ground in the common pool 210, and all the coolant within the common pool 210 may be used for cooling the spent nuclear fuel under the normal operation, and thus, the possibility of exposure to the air may be significantly low.

Hereinafter, a method for removing the decay heat using the reactor modularization system 1000 in the accident condition will be described in detail.

The most important factor in the accident condition is to ensure the long-term cooling performance by stably removing the decay heat. The present invention relates to a technology capable of securing the long-term passive cooling performance in various accident scenarios depending on whether the coolant leaks, and the electric power (AC) is available. Basically, the valves that operate in the passive and active manners to secure multiplicity during the emergency injection may be installed so that the emergency injection into the individual cavities are performed in both in the common and auxiliary pools.

First, in another aspect of the present invention, a method for removing decay heat using the reactor modularization system under a coolant leakage accident includes a process of performing emergency injection into each of cavities of a reactor building using a coolant of a common pool and a process of cooling an outer wall of a containment vessel and transferring decay heat of steam, which is discharged through a gap of the containment vessel from the reactor vessel, to an external coolant through condensation heat transfer.

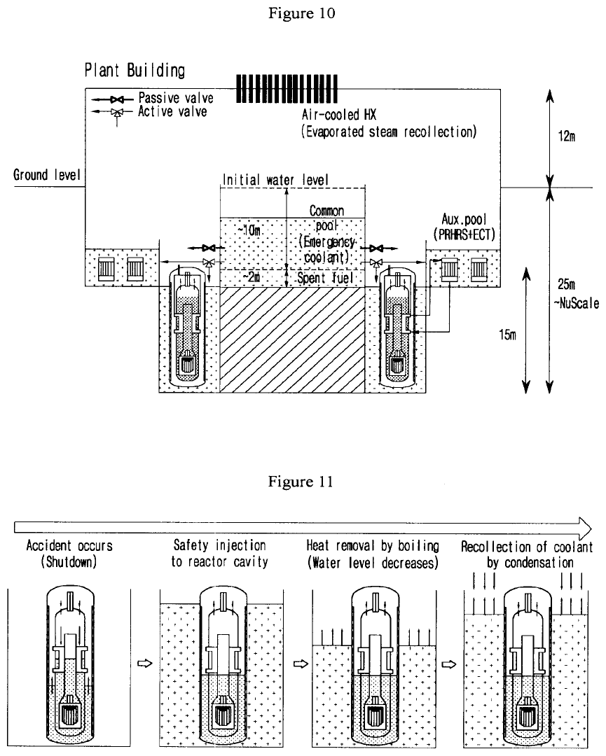

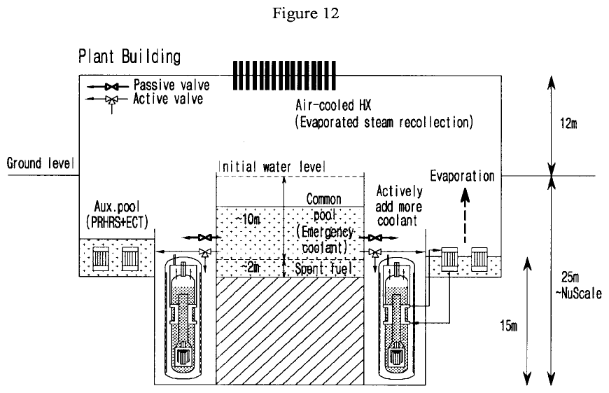

The coolant leakage accident condition may be, for example, an accident condition such as damage of the reactor vessel or an operation of an overpressure prevention valve due to station blackout. In the case of the coolant leak accident, the steam may be discharged through the gap 30 between the containment vessels 20. In order to remove the decay heat, the emergency injection is performed into the individual cavities 220, in which the reactors 100 are respectively disposed, using the coolant of the common pool 210 (see FIG. 10). When electric power (AC) is lost, water is uniformly injected into all the cavities 220 through the passive valve 214. When the power is turned on, the active valve 213 disposed at a side of the cavity 220 in which the reactor 100, in which the accident occurs, is located may operate to cool only a module (configuration of the reactor disposed in the cavity) in which the accident occurs.

When the emergency injection is performed, the outer wall of the containment vessel 20 is cooled, and the steam discharged through the gap 30 from the containment vessel 20 transfers decay heat to the external coolant through the condensation heat transfer. The condensed water is collected in a lower portion of the gap 30 and then is reintroduced into the reactor vessel through a recirculation valve (not shown) disposed at a specific height, and thus, a core water level inside the reactor vessel is maintained constantly. The emergently injected coolant initially removes the decay heat without decreasing in water level through sensible heat, and when a saturation temperature is reached, boiling occurs, and the water level gradually decreases. However, since decay heat removing efficiency decreases as the water level decreases, long-term cooling performance may be secured by condensing and recollecting the steam generated by boiling again as illustrated in FIG. 11 so as to secure the long-term cooling performance. As illustrated in FIG. 5, the condensation of the steam is performed through a method of condensing the steam discharged from the cavity 220 by boiling through an air-cooled type heat exchanger 240 installed on an upper portion of the reactor building 200 to recover the water level in the common pool 210 or collect the steam into the cavity 220 so as to recover the water level again.

Next, in another aspect of the present invention, a method for removing decay heat using the reactor modularization system under an accident condition without a coolant leakage includes a process of passively removing the decay heat through a passive residual heat removal system to which a steam generator in a reactor vessel and heat exchangers for passively removing the residual heat inside an auxiliary pool are connected.

The accident condition without the coolant leakage may be, for example, an accident condition such as a main steam line break accident, a total loss of feed water accident, and the like. In the case of the accident in which there is no coolant leakage, the removing of the decay heat is performed by passively removing the decay heat due to natural circulation through a passive residual heat removal system connected to a heat exchanger 231 for passively removing residual heat within an auxiliary pool 230 in a steam generator 12 of the reactor 100. The coolant in the auxiliary pool 230 boils due to the transferred decay heat, and thus, a water level decreases. Here, additional coolant may be supplied from a common pool 210 through a pipe connected to the common pool 210 and an active valve 215. If the coolant level in the auxiliary pool 230 is maintained, cooling may be maintained for a long time. The steam generated by the boiling may be re-collected into the common pool 210 through air-cooling of a reactor building 200 to significantly secure an accident response time.

In the present invention, the gap 30 between the reactor vessel 10 and the containment vessel 20 under the normal operation condition may be maintained in the atmospheric pressure state and the air atmosphere so as not to require any additional maintenance technology during the nuclear fuel replacement cycle when compared to the existing technology, and the replaceable aluminum-based thermal radiation shield 21 may be installed on the inner wall of the installation containment vessel 20 to reduce the heat loss that increasing due to the air convection.

In addition, the technology of disposing the two or more reactors 100 in the individual cavities 220 by using the common pool 210 proposed in the present invention as a center may have the advantage in terms of the heat loss and the corrosion in that the reactors 100 operate under the non-submerged condition during the normal operation when compared to the existing technology and may solve the limitations of the existing technology, in which one module accident affects the surrounding modules.

Therefore, in the event of the single module accident, the sufficient amount of coolant may be continuously supplied to the module in which the accident occurs to secure the long-term cooling performance even with the core heat output greater than that of the small modular reactor according to the related art.

In the reactor provided in one aspect of the present invention, the air layer having the excellent thermal insulation effect may be formed to surround the reactor vessel inside the containment vessel, and an aluminum-based replaceable thermal radiation shield is provided on the inner wall of the containment vessel to prevent the additional heat loss due to the thermal radiation from occurring.

The reactor modularization system provided in another aspect of the present invention may be the concept of including the multipurpose common pool to be disposed at the center within the reactor building, and the two or more small modular reactors are disposed therearound, and the small modular reactors may be disposed in the underground cavity in the dry condition without water to minimize the heat loss during the normal operation. The main role of the coolant in the common pool may manage the spent nuclear fuel during the normal operation and fill the emergency coolant to the reactor module cavity in which the reactor is installed in the event of the accident, and the filled coolant may act as the final heat sink, which cools the outer wall of the metal containment vessel, thereby performing the condensation of the discharged steam inside the containment vessel.

The reactor capable of performing the above-described function and the reactor modularization system including the same may improve the power plant efficiency by minimizing the heat loss during the normal operation of the small modular reactor having the relatively high reactor output. In addition, the final heat sink may be provided to the reactor, in which the accident occurs, through the filling in the event of the accident, to secure the accident response time in the long term, thereby improving the safety of the nuclear power plant.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A reactor comprising:
a reactor vessel; and
a containment vessel configured to surround the reactor vessel,
wherein the containment vessel comprises a thermal radiation shield disposed on an inner wall, and
a gap between the reactor vessel and the containment vessel is in an atmospheric pressure and air atmosphere state.

2. The reactor of claim 1, wherein the thermal radiation shield is made of an aluminum-based metal.

3. The reactor of claim 1, wherein the atmospheric pressure state is in a pressure range of about 1.0 atm to about 1.2 atm.

4. A reactor modularization system comprising a reactor building in which at least two reactors of claim 1 are disposed,
wherein the reactor building comprises:
a common pool in which coolant is contained;
at least two cavities which are defined in an outer circumferential surface of the common pool and in which the reactors are disposed, respectively.

5. The reactor modularization system of claim 4, wherein the cavities are maintained in a dry condition.

6. The reactor modularization system of claim 4, wherein the reactor building comprises an auxiliary pool which is disposed on the outer circumferential surface of the common pool and connected to the common pool through a pipe and in which the coolant is contained.

7. The reactor modularization system of claim 6, wherein the auxiliary pool comprises a heat exchanger for removing passive residual heat, which is connected to a steam generator within the reactor vessel.

8. The reactor modularization system of claim 4, wherein the reactor building comprises an air cooling type heat exchanger configured to condense steam at an upper portion of the common pool.

9. The reactor modularization system of claim 4, wherein the common pool is divided into an upper portion and a lower portion,
wherein the upper portion is an aboveground portion at which the coolant is disposed, and the lower portion is an underground portion at which the coolant and a spent nuclear fuel are disposed.

10. The reactor modularization system of claim 4, wherein the common pool comprises an active valve and a passive valve, which are configured to inject the coolant into the cavities.

11. The reactor modularization system of claim 6, wherein the common pool comprises an active valve configured to inject the coolant into the auxiliary pool.

12. A method for removing decay heat using the reactor modularization system of claim 4 under accident conditions with coolant leakage, the method comprising:
performing emergency injection into each of cavities of a reactor building using a coolant of a common pool; and
cooling an outer wall of a containment vessel through emergency injection and transferring decay heat of stream, which is discharged through a gap of the containment vessel from the reaction vessel, to an external coolant through condensation heat transfer.

13. The method of claim 12, wherein condensed water generated by condensation of the steam in the method for removing the decay heat is collected into a lower portion of the gap, and the collected condensed water is recirculated to maintain a water level within the reactor vessel.

14. The method of claim 12, wherein, in the reactor modularization system, the reactor building comprises an air-cooling type heat exchanger configured to condense steam at an upper portion of the common pool, and
in the method for removing the decay heat, the steam generated by boiling when emergently injected coolant reaches a saturation temperature is recollected by re-condensing the steam through an air-cooling type heat exchanger.

15. A method for removing decay heat using the reactor modularization system of claim 7 Under accident conditions with no coolant leakage, the method comprising:
a process of passively removing the decay heat through a passive residual heat removing system to which a steam generator in a reactor vessel and a heat exchanger for removing passive residual heat inside an auxiliary pool are connected.
